(19) United States
(12) Patent Application Publication
(10) Pub. No.: US 2008/0245600 A1
(43) Pub. Date: Oct. 9, 2008

(54) Electric Power Steering Apparatus

(75) Inventor: Kazuo Chikaraishi, Gunma (JP)

Correspondence Address: SUGHRUE MION, PLLC, 2100 PENNSYLVANIA AVENUE, N.W., SUITE 800, WASHINGTON, DC, 20037, US

(73) Assignee: NSK STEERING SYSTEMS CO., LTD.

(21) Appl. No.: 10/575,259

(22) PCT Filed: Oct. 7, 2004
(86) PCT No.: PCT/JP2004/015211

§ 371 Date: Apr. 10, 2006

(30) Foreign Application Priority Data
Oct. 10, 2003 (JP) 2003-352552

(51) Int. Cl. B62D 5/04

(52) U.S. Cl. 180/444

(57) ABSTRACT

The present invention relates to an electric power steering apparatus for assisting steering of a steering shaft by the rotation power of an electric motor through a reducer based on the steering torque detected by a torque sensor. A rotary potentiometer is disposed in the reducer, and a portion of a swing arm of the potentiometer is engaged with a swirl groove formed on the side of a worm wheel in the reducer as well as the swing arm is swingingly rotated according to the rotation of the worm wheel to thereby detect the rotation angle of the steering shaft.

### FIELD OF THE INVENTION

The present invention relates to an electric power steering apparatus for applying steering assistant power from an electric motor to a steering system of an automobile and a vehicle, and more particularly to an improvement of an angle detector for detecting the rotation angle (steering angle) of a steering shaft.

### BACKGROUND OF THE INVENTION

Ordinarily, an electric power steering device is mounted on a vehicle to reduce a load on a driver by assisting steering power when the vehicle is driven. The electric power steering apparatus assists the steering operation of a steering shaft by transmitting the rotating force of an electric motor to the steering shaft through a reducer.

Recently, a stability control apparatus is mounted on an automobile to prevent spin caused by under steering and over steering by individually controlling brake forces acting on respective wheels according to a state of the automobile. Further, technologies for automatically carrying out parallel parking based on vehicle information, and the like are also researched. Since a steering angle detection means for detecting a steering angle is necessary to execute these technologies, an angle detector is mounted on the electric power steering apparatus.

Magnetic and optical incremental encoders and the like, for example, are used as this type of angle detectors. These encoders use the angle at the time they start as a point of origin and detects a relative angle from the point of origin just after they start.

Further, Japanese Patent Application Laid-Open Publication No. 2002-340511, for example, discloses an angle detector as an absolute type angle detector that can detect the range of 360°. As shown in FIG. 1, in Japanese Patent Application Laid-Open Publication No. 2002-340511, the angle detector includes a first gear 102 mounted on a steering shaft 101 and a second gear 104 mounted on a permanent magnet 103, and these gears are engaged through a reduction gear 105 so that the rotation of a steering wheel can be transmitted to the permanent magnet 103. Further, the angle detector is arrange such that the permanent magnet 103 is rotated just 360° within the range of rotation of the steering wheel of a wheel by the gear ratio of the first gear 102 and the reduction gear 105 and the gear ratio of the second gear 104 and the reduction gear 105. Then, as shown in FIG. 2, an MR element 106 connected to an arithmetic operation unit 107 includes magnetic coils 108, 109 disposed at a different angle each other, and the information of absolute rotation angle of the steering wheel is created by the combination of the MR element 106 and the permanent magnet 103 based on a flux-direction-changing waveform obtained by superimposing the flux of the permanent magnet 103 and the flux resulting from the magnetic fields generated by the magnetic coils 108, 109.

However, in the conventional angle detector as described above, since the point of origin is set to the angle when the detector starts, an absolute angle from the neutral position of the steering wheel cannot be detected at once. Accordingly, it is necessary to set the neutral position by estimating it while traveling some time. Further, the angle detector has a problem in that since its cost is expensive, a manufacturing cost is increased.

Further, although the angle detector of Japanese Patent Application Laid-Open Publication No. 2002-340511 can detect the range of 360° in the absolute angle, since the steeling wheel is ordinary rotated about three times from lock to lock, an output value when it is rotated once cannot be discriminated from that when it is rotated twice. Further, when the steering wheel is rotated in the off-state of ignition, whether or not a detected value is correct cannot be determined.

Further, to detect the absolute angle in an entire area, the amount of rotation of the permanent magnet 103 as a detection unit must be set to one revolution or less. Accordingly, the reduction gear 105 is interposed between the steering shaft 101 and the permanent magnet 103, from which a problem arises in that the number of parts is increased and a cost is increased thereby.

Further, the construction of the conventional angle detector described above is disadvantageous in that since a space in which the angle detector is installed is necessary in the axial direction of the steering shaft, a stroke for absorbing energy when collision occurs is sacrificed.

### SUMMARY OF THE INVENTION

Accordingly, an object of the present invention is to provide an angle detector that permits to effectively use the space of a steering shaft in the axial direction thereof and can accurately detect an absolute angle in the entire area of a steering wheel from lock to lock at low cost by mounting a rotary potentiometer on a worm wheel in a reducer.

The object of the present invention can be achieved by an electric power steering apparatus for assisting steering of a steering shaft by the rotation power of an electric motor through a reducer based on the steering torque detected by a torque sensor, wherein a rotary potentiometer is disposed in the reducer, and a portion of a swing arm of the potentiometer is engaged with a swirl groove formed on the side of a worm wheel in the reducer as well as the swing arm is swingingly rotated according to the rotation of the worm wheel to thereby detect the rotation angle of the steering shaft.

The object can be effectively achieved by that the worm wheel comprises a metal core portion and a resin portion with a gear formed on the outer peripheral surface thereof and the swirl groove is formed to the resin portion.

The object can be effectively achieved by that the swirl groove is molded integrally with the resin portion at the same time.

The object can be effectively achieved by that the worm wheel comprises a metal core portion and a resin portion with a gear formed on the outer peripheral surface thereof, and the swirl groove is formed to the metal core portion.

The object can be effectively achieved by that the swirl groove is formed integrally with the metal core portion.

The object can be effectively achieved by that the swirl groove is formed to a to-be-detected member separated from the worm wheel, and the to-be-detected member is attached to the side of the worm wheel.

According to the electric power steering apparatus of the present invention, the angle detector for detecting the steering state of the steering wheel is composed of the rotary potentiometer with the swing arm, and a part of the swing arm is fitted into the swirl groove formed to the side surface of the worm wheel as well as the swing arm is swingingly rotated according to the rotation of the worm wheel. With this arrangement, the absolute angle can be accurately detected in the entire range of the steering wheel from lock to lock even just after a voltage is applied.

Further, since the angle detector can be disposed in a minute space in the axial direction of the steering shaft, a stroke for absorbing the energy of the electric power steering apparatus is not sacrificed as well as safety can be kept to a load due to shock. Further, since the angle detector is not complex in structure and composed of the smaller number of parts, it can be manufactured at low cost.

### BRIEF DESCRIPTION OF DRAWINGS

FIG. 1 is a schematic configuration view of a conventional angle detector.

FIG. 2 is a configuration view of a main portion of the conventional angle detector.

FIG. 3 is a sectional view of a main portion showing the construction of an electric power steering apparatus according to a first embodiment of the present invention.

FIG. 4 is a sectional view of a reducer unit of the electric power steering apparatus taken along the line X-X of FIG. 3.

FIG. 5 is a configuration view of a rotary potentiometer disposed in the reducer unit.

FIG. 6 is a graph showing the relation between the output voltage of the potentiometer and the rotation angle of a steering shaft.

FIG. 7 is a circuit diagram of the rotary potentiometer having resistor elements disposed in two paths.

FIG. 8 is a sectional view of a main portion showing the construction of an electric power steering apparatus according to a second embodiment of the present invention.

FIG. 9 is a sectional view of a main portion showing the construction of an electric power steering apparatus according to a third embodiment of the present invention.

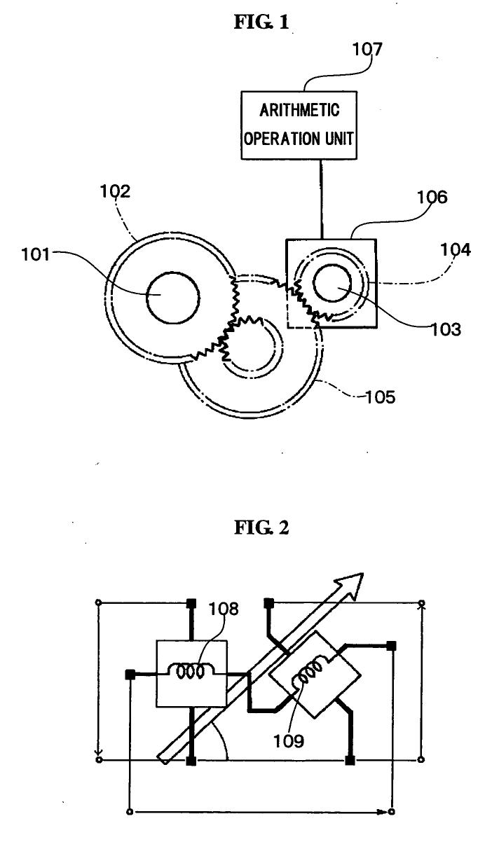

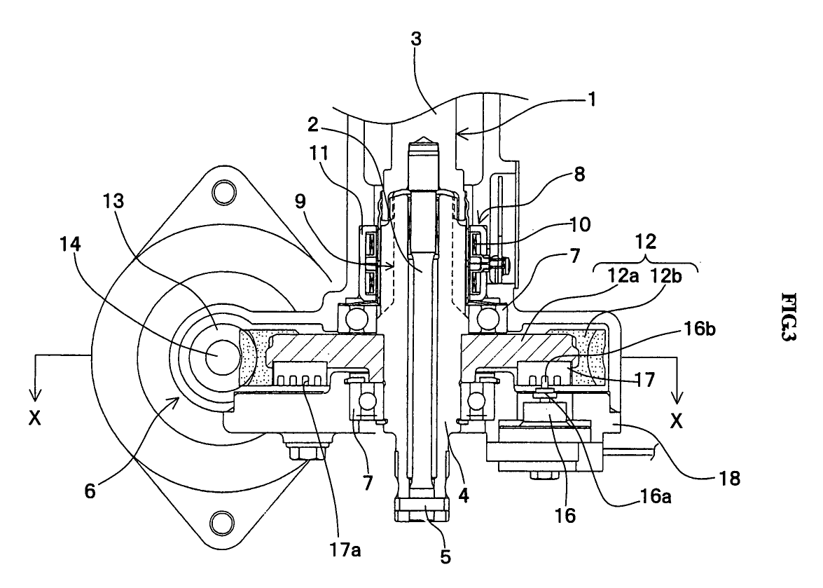

### DESCRIPTION OF REFERENCE SYMBOLS

1 steering shaft
6 reducer unit
8 torque sensor
12 worm wheel
12a metal core portion
12b resin portion
15 electric motor
16 rotary potentiometer
16a swing arm
16b engagement pin
17 to-be-detected member
17a swirl groove

### DESCRIPTION OF THE PREFERRED EMBODIMENTS

Embodiments of the present invention will be described below in detail based on the drawings.

FIG. 3 is a sectional view showing a main portion of the construction of an electric power steering apparatus according to a first embodiment of the present invention. A steering shaft 1 rotated in association with the operation of a steering wheel is coupled with an input shaft 3 and an approximately cylindrical output shaft 4 through a torsion bar 2. The torsion bar 2 is inserted into the output shaft 4 and has an end press-fitted into the input shaft 3 under pressure and secured thereto and the other end secured to the output shaft 4 by a pin 5.

Further, a reducer unit 6 is supported on the outer periphery of the output shaft 4 through a pair of ball bearings 7, 7 as well as a torque sensor 8 is disposed to the leading end side(on the left side of FIG. 3) of the reducer unit 6. The torque sensor 8 includes the torsion bar 2 and an electromagnetic yoke 11, the electromagnetic yoke 11 is disposed on the outer periphery of a spline groove 9 formed at the leading end portion of the output shaft 4 and accommodate a coil winding 10 therein, and the torque sensor 8 detects a magnetic change by a coil winding 10 in the electromagnetic yoke 11 based on the torsion of the torsion bar 2 caused according to the torque generated in the steering shaft 1.

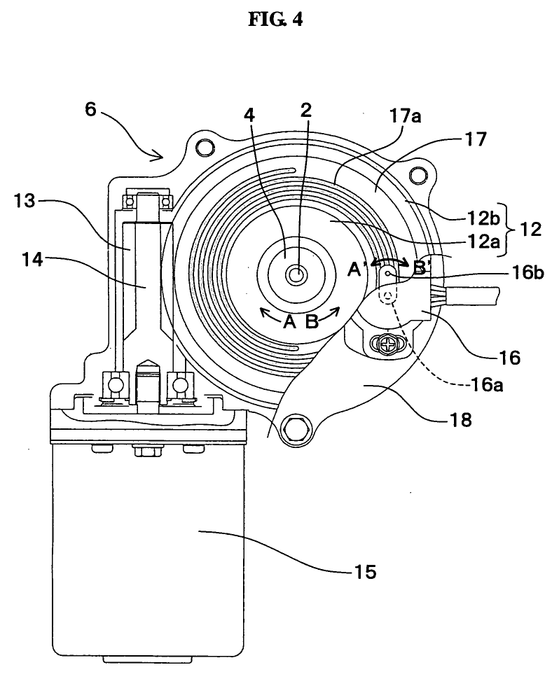

Further, the reducer unit 6 is composed of a worm wheel 12, which includes a metal core portion 12a and a resin portion 12b with a gear formed on the outer peripheral surface thereof and is press-fitted on the outer periphery of the output shaft 4, a worm 13 engaged with the worm wheel 12, and an electric motor 15 (FIG. 4) having a drive shaft 14 to which the worm 13 is attached. When the electric motor 15 is driven, the rotation thereof is reduced through the worm 13 and the worm wheel 12 so that steering assistant power can be transmitted.

FIG. 4 shows a sectional view of the reducer unit 6 taken along the line X-X of FIG. 3. A rotary potentiometer 16 for detecting the rotation angle of the steering wheel 12 includes a swing arm 16a that swingingly rotates right and left, the swing arm 16a has an engagement pin 16b at the leading end thereof, and the engagement pin 16b is engaged with a swirl groove 17a of a to-be-detected member 17 attached to the side surface of the worm wheel 12. In the embodiment, the swirl groove 17a is formed to detect the three revolutions (±540°) of the steering wheel 1 in correspondence to the range from lock to lock of the steering wheel. When the worm wheel 12 rotates in the direction of an arrow A, the swing arm 16a swingingly rotates in the direction of an arrow A′, whereas when the worm wheel 12 rotates in the direction of an arrow B, the swing arm 16a swingingly rotates in the direction of an arrow B′.

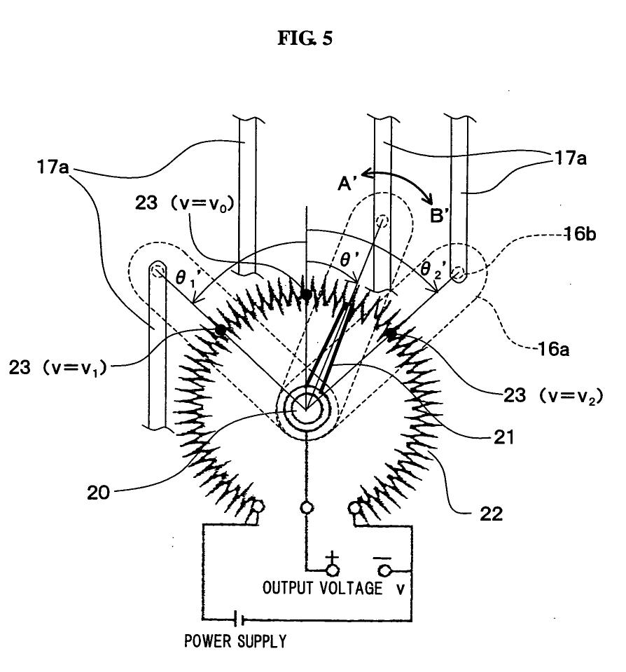

Further, as shown in FIG. 5, a central shaft 20 coupled with the swing arm 16a and a slider 21 secured to the central shaft 20 rotate in the potentiometer 16 in association with the swinging rotation of the swing arm 16a. Then, the leading end of the slider 21 moves in sliding contact with a resistor element 22 disposed circularly and outputs an output voltage v according to the position of a sliding contact point thereof. Further, to set the neutral point (rotation angle: 0°) of the steering wheel 1, the engagement pin 16b is engaged with the swirl groove 17a at the predetermined position thereof in a state that the steering wheel 1 is locked at a neutral position, and the phase between a gear housing 18 and the potentiometer 16 is adjusted, thereby the potentiometer 16 is mounted to output a predetermined neutral voltage v₀. That is, a sliding contact point 23 at which the predetermined neutral voltage v₀ is output is set as the neutral point 23 (v=v₀).

As the slider 21 moves in the A′ direction, the output voltage v is reduced, whereas as the slider 21 moves in the B′ direction, the output voltage v is increased, and the output voltage v is in proportion to a swing rotation angle θ′. The slider 21 and the swing arm 16a swing in the range from θ₁′ at which the engagement pin 16b is located on the innermost periphery of the swirl groove 17a to θ₂′ at which it is located on the outermost periphery thereof.

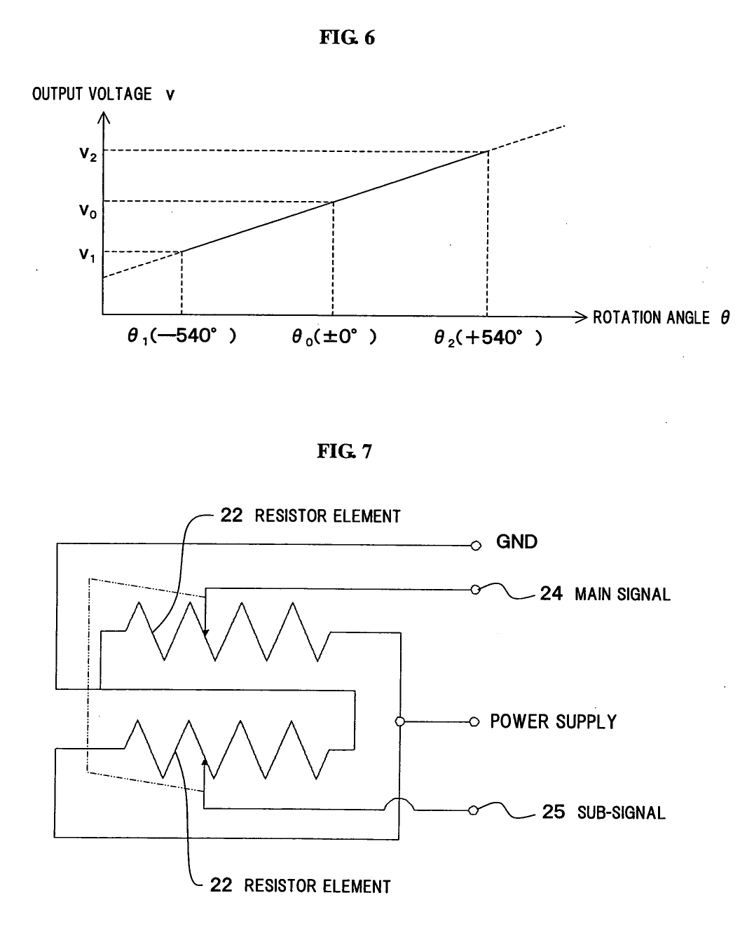

Further, since the swirl groove 17a is formed such that the swing rotation angle θ′ is in a proportional relation to the rotation angle E of the steering wheel 1, the output voltage v is in proportion to the rotation angle θ as shown FIG. 6. Accordingly, it is not necessary to provide a means which is conventionally required to discriminate a plurality of the same values due to a triangle-wave output. As a result, even just after a voltage is applied, an absolute angle can be accurately detected in the entire range from lock to lock (θ₁ to θ₂) of the steering wheel by determining a characteristic value between the output voltage v and the rotation angle θ.

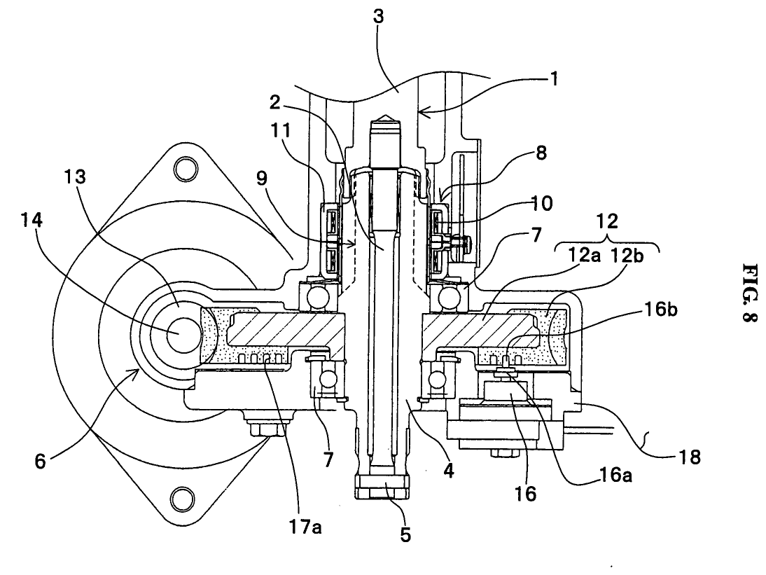

Note that, as shown in a circuit diagram of FIG. 7, a circuit in the potentiometer 16 may be provided with the resistor element 22 disposed in two paths so that two signals, that is, a main signal 24 and a sub-signal 25 can be output. Reliability of detection of the absolute angle can be improved by arranging the main and sub signals 24, 25 such that they have inverse output characteristics.

Further, in the first embodiment, the to-be-detected member 17 is disposed in the reducer unit 6 as well as the potentiometer 16 is disposed outward of the ball bearings 7 of the output shaft 4 in a radial direction. Accordingly, it is not necessary to form a space dedicated for the angle detector on the steering shaft 1 different from a conventional angle detector. As a result, the stroke of an energy absorption mechanism can be increased in an axial direction of the steering shaft 1, thereby an energy absorption capability to a load due shock can be prevented from being sacrificed. Further, since the angle detector is simpler in structure and has the smaller number of parts than the conventional angle detector, the angle detector having a higher detection accuracy can be manufactured at low cost.

Note that, in the first embodiment described above, the swirl groove 17a is attached to the to-be-detected member 17. The to-be-detected member 17 is formed to the worm wheel 12, and the potentiometer 16 is disposed such that the engagement pin 16b is fitted into the swirl groove 17a. However, the attachment positions of the to-be-detected member 17 and the potentiometer 16 are not limited thereto and may be attached near to the axial center or the outer periphery of the worm wheel 12 as long as the to-be-detected member 17 is attached to the side surface of the worm wheel 12 such that it is associated with the rotation of the worm wheel 12.

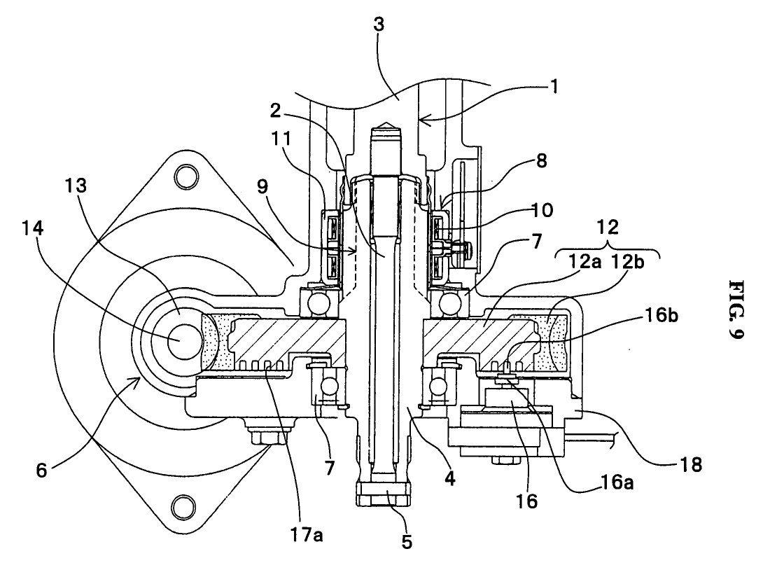

FIG. 8 shows a second embodiment of the present invention, wherein the same components as those in the first embodiment are denoted by the same reference numerals and the explanation thereof is omitted. In the figure, a swirl groove 17a is formed in a resin portion 12b of a worm wheel 12 integrally therewith.

Accordingly, in the second embodiment, the number of parts can be reduced in addition to the operation/working effect of the first embodiment by not disposing a to-be-detected member 17, thereby an angle detector can be manufactured at low cost. Further, the swirl groove 17a may be molded simultaneously with the resin portion 12b in a manufacturing process of the worm wheel 12, thereby a manufacturing job can be reduced.

FIG. 9 shows a third embodiment of the present invention, wherein the same components as those of the first embodiment are denoted by the same reference numerals and the explanation thereof is omitted. In the figure, a swirl groove 17a is formed in a metal core portion 12a of a worm wheel 12 integrally therewith.

Accordingly, the same operation/working effect as the second embodiment can be achieved by not disposing a to-be-detected member 17. Further, the swirl groove 17a may be molded at the same time a metal core portion 12a is cold molded in the manufacturing process of the worm wheel 12 or may be formed in a processing executed afterward.

### INDUSTRIAL APPLICABILITY OF THE INVENTION

As described above, the steering angle detector according to the present invention is suitable as a means used to detect a steering angle in a steering apparatus and particularly useful when it is desired to detect an absolute angle in a wide range.

1. An electric power steering apparatus for assisting steering of a steering shaft by the rotation power of an electric motor through a reducer based on the steering torque detected by a torque sensor, wherein:
a rotary potentiometer is disposed in the reducer, and a portion of a swing arm of the potentiometer is engaged with a swirl groove formed on the side of a worm wheel in the reducer as well as the swing arm is swingingly rotated according to the rotation of the worm wheel to thereby detect the rotation angle of the steering shaft.

2. The electric power steering apparatus according to claim 1, wherein the worm wheel comprises a metal core portion and a resin portion with a gear formed on the outer peripheral surface thereof, and the swirl groove is formed to the resin portion.

3. The electric power steering apparatus according to claim 2, wherein the swirl groove is molded integrally with the resin portion at the same time.

4. The electric power steering apparatus according to claim 1, wherein the worm wheel comprises a metal core portion and a resin portion with a gear formed on the outer peripheral surface thereof, and the swirl groove is formed to the metal core portion.

5. The electric power steering apparatus according to claim 4, wherein the swirl groove is formed integrally with the metal core portion.

6. The electric power steering apparatus according to claim 1, wherein the swirl groove is formed to a to-be-detected member separated from the worm wheel, and the to-be-detected member is attached to the side of the worm wheel.
